(19) United States
(12) Patent Application Publication
(10) Pub. No.: US 2013/0112502 A1
(43) Pub. Date: May 9, 2013

(54) Ladder Caddy

(71) Applicant: Linda OLIVER, Lexington, TN (US)

(72) Inventor: Linda OLIVER, Lexington, TN (US)

(21) Appl. No.: 13/670,999

(22) Filed: Nov. 7, 2012

Related U.S. Application Data
(60) Provisional application No. 61/557,038, filed on Nov. 8, 2011.

(51) Int. Cl. E06C 7/14; B65D 90/12

(52) U.S. Cl. 182/129; 220/628

(57) ABSTRACT

A ladder caddy, including a planar panel having an upper surface, a lower surface and a height, at least one first aperture defined in the planar panel and extending through the height of the planar panel, and at least one lip extending from the lower surface of the planar panel, the at least one lip circumscribing a first recess.

### CROSS-REFERENCE TO RELATED APPLICATIONS

This application claims priority to U.S. Provisional Application 61/557,038, filed Nov. 8, 2011 and entitled LADDER CADDY, the entire contents of which are hereby incorporated by reference.

### BACKGROUND

Ladders, stepstools and similar apparatuses are traditionally used to access roofs, utility lines, and other hard to reach places in need of repairs, cleaning, or other work. While working from a ladder, a person will frequently be required to hold tools in a tool belt or some other type of tool carrier. However, tool belts, backpacks and other such tool carriers used to hold additional tools, supplies and other equipment are inconvenient and can be unsafe. Many of these devices store the equipment on the worker's backside, which places additional weight on a worker. This weight, and the forces created by it, can alter the center of gravity of a worker, which can lead to the worker losing his or her balance, especially if the worker slips, missteps or moves the body into a poorly balanced position. If a person using a ladder wishes to avoid these risks, he or she may climb up and down the ladder each time he or she requires a new tool, but this method is inefficient and burdensome.

Many known systems that allow a user to store materials or equipment on a ladder are insufficient for organizing the user's equipment. Further, many of these systems require extensive setup or installation. In light of these disadvantages, a ladder storage system which minimizes the movement required from the user, enhances storage organization, and is easy to set up, is desirable.

### SUMMARY

According to at least one exemplary embodiment, a ladder caddy is disclosed. The ladder caddy can include a planar panel having an upper surface, a lower surface and a height, at least one first aperture defined in the planar panel and extending through the height of the planar panel, and at least one lip extending from the lower surface of the planar panel, the at least one lip circumscribing a first recess. The ladder caddy can further include a plurality of second apertures defined in the planar panel and extending through the height of the planar panel, and a plurality of second recesses defined in the upper surface of the planar panel.

According to another exemplary embodiment, a ladder is disclosed. The ladder can include a top panel, the top panel being planar and having an upper surface, a lower surface and a height, at least one first aperture defined in the top panel and extending through the height of the top panel, and at least one pair of rails coupled to the top panel. The ladder can further include a plurality of second apertures defined in the top panel and extending through the height of the top panel, and a plurality of second recesses defined in the upper surface of the top panel.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a top isometric view of an exemplary embodiment of a ladder caddy;

FIG. 2 is a top view of an exemplary embodiment of a ladder caddy;

FIG. 3 is a is a bottom view of an exemplary embodiment of a ladder caddy;

FIG. 4 is a bottom isometric view of an exemplary embodiment of a ladder caddy;

FIGS. 5a-5c are bottom views of other exemplary embodiments of a ladder caddy;

FIG. 6 is a top isometric view of an exemplary embodiment of a ladder caddy in use on a ladder; and

FIG. 7 is a top isometric view of an exemplary embodiment of a ladder.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

According to at least one exemplary embodiment, a ladder caddy is disclosed. The ladder caddy can be configured to fit over the top of a ladder. The ladder caddy may include a plurality of apertures, recesses, pockets, and other storage compartments for receiving a user's equipment, for example tools, supplies, fasteners, and any other hardware or equipment. The ladder caddy may further include a central aperture for allowing a large container or receptacle, for example a bucket, to be placed therein. The ladder caddy may further include structures to facilitate coupling the caddy to a ladder and to facilitate a secure coupling between the caddy and the ladder.

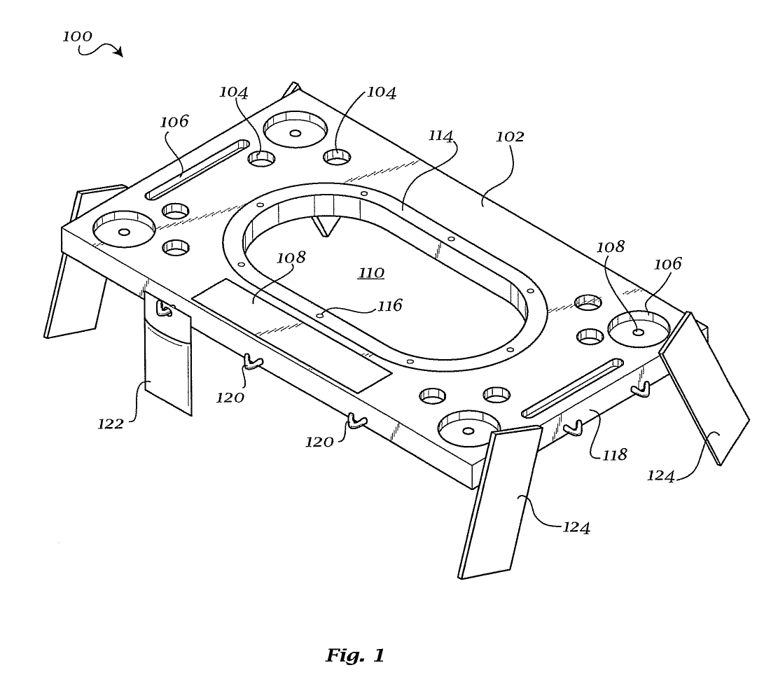

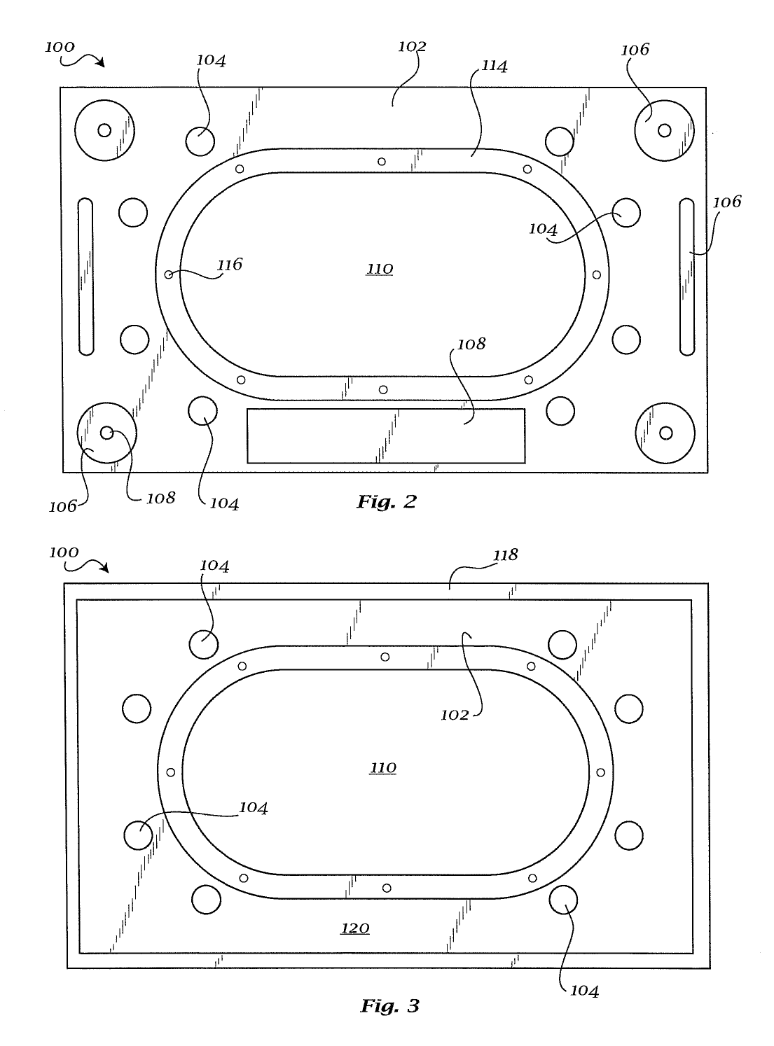

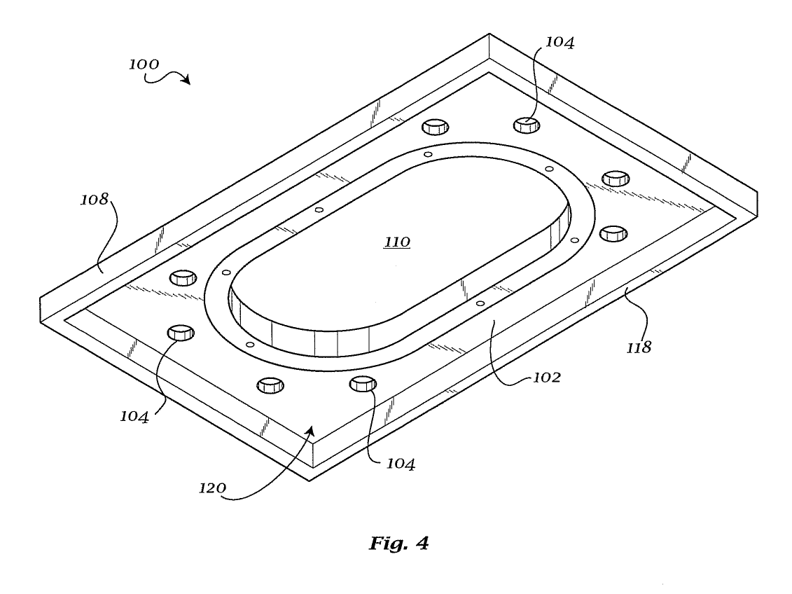

FIGS. 1-6 show an exemplary embodiment of a ladder caddy 100. Caddy 100 may be formed from any suitable material, for example plastic, metal, wood, and so forth. Caddy 100 may include a panel 102, which may be substantially planar. Panel 102 may be formed from any desired material and may have any desired shape, for example rectangular, circular, and so forth. Panel 102 may have any length, width and thickness that enable caddy 100 to function as described herein. Panel 102 may be manufactured with any desired dimensions that can allow caddy 100 to be adaptable to commonly known ladder sizes and ladder configurations, including, but not limited to, step ladders and full size ladders.

Panel 102 may have at least one aperture 104, or a plurality of apertures 104, defined therein. Apertures 104 may have any desired size and shape that enables caddy 100 to function as described herein. For example, apertures 104 may have a circular shape, oval shape, rectangular or rounded-rectangular shape, and so forth. The apertures may extend through the entire thickness of panel 102. The apertures 104 may be used, for example, to retain tools such as hammers, brushes, or any similar tool having a narrow end and a wide end having a width greater than a width of aperture 102. The narrow end of the tool may pass through aperture 104, while the wide end of the tool may engage panel 102 and/or the periphery of aperture 104, thereby maintaining the tool or tools within the aperture and easily accessible to the user.

Panel 102 may further include at least one recess 106, or a plurality of recesses 106, defined in an upper surface thereof. Recesses 106 may have any desired size and shape that enables caddy 100 to function as described herein. For example, recesses 106 may have a circular shape, oval shape, rectangular or rounded-rectangular shape, and so forth. Recesses 106 include a bottom surface extending between the walls of the recesses. Recesses 106 may have a height that is less then the thickness of panel 102, or may have a height that is equal to or greater than the thickness of panel 102. The recesses 106 may be used, for example, to retain objects such as small tools, accessories, and other supplies, for example fasteners and the like. Recesses 106 may further include separators, which may be fixed or movable separators, so as to allow the user to separate the various objects within recesses 106.

Caddy 100 may also include at least one magnetic element 108, or a plurality of magnetic elements 108. The magnetic elements 108 may be used to retain paramagnetic items. The magnetic elements may be located within a recess 106, on the surface of panel 102, or in any other desired location. In some exemplary embodiments, a portion of, or the entirety of the surface of panel 102 may be magnetized or may include at least one magnetic element 108.

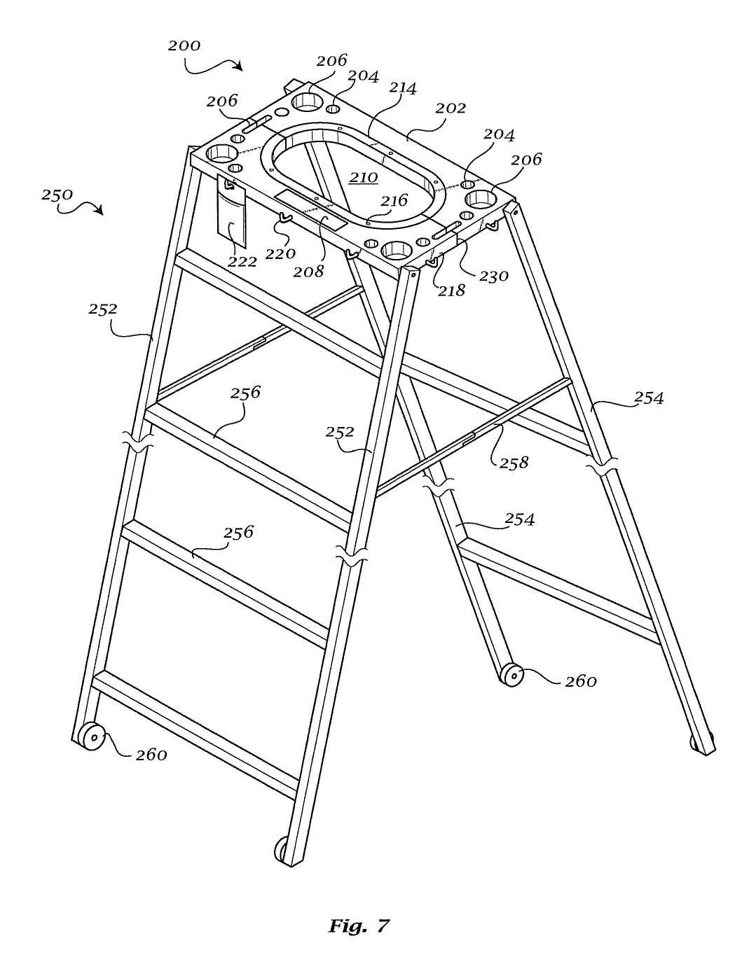

A central aperture 110 may be defined within panel 102. Central aperture 110 may have any desired size and shape that enables caddy 100 to function as described herein. For example, central aperture 110 may have a circular shape, oval shape, rectangular or rounded-rectangular shape, and so forth. The central aperture may extend through the entire thickness of panel 102. Central aperture 110 may be sized and shaped to receive a large item or container, such as a bucket 112, as shown in FIG. 6. Central aperture 110 may further be bounded by a reinforcing member 114, which may be made of any desired material, for example metal. Reinforcing member 114 may be coupled to panel 102 by any desired coupling, for example adhesive or a plurality of fasteners 116. Reinforcing member 114 can facilitate reduce the wear on the edges of central aperture 110 and can therefore be formed of a material having a greater hardness than the material from which panel 102 is formed.

Extending from a lower surface of panel 102 may be at least one lip 118. Lip 118 may have a substantially rectangular configuration and may have any width and height that allows caddy 100 to function as described herein. Lip 118 may engage the top of a ladder and, to that end, may circumscribe a recess 120. The top of ladder may then be received within recess 120, while the edges of the top of the ladder may be engaged by lip 118. Consequently, lip 118 can serve to restrict the horizontal movement of caddy 100 in relation to the top of the ladder.

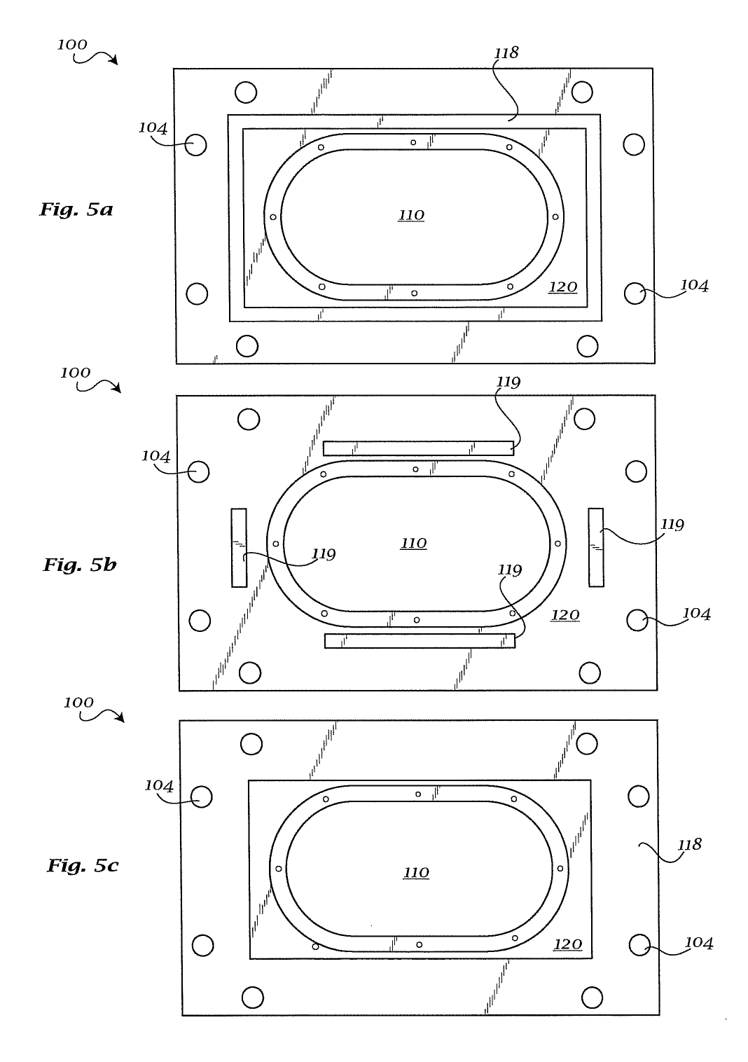

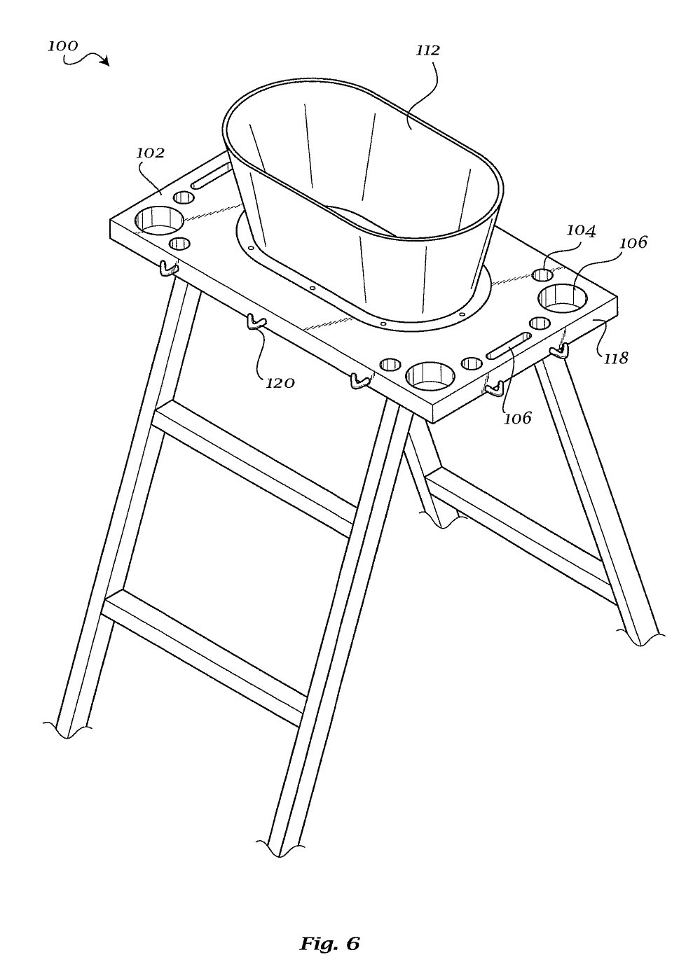

The dimensions of lip 118 may be varied based on common dimensions for ladder tops. As the size of panel 102 may be varied as desired, in some exemplary embodiments, 118 may be disposed adjacent the periphery of panel 102, as shown in FIG. 3. In other exemplary embodiments, as shown in FIG. 5a, the periphery of panel 102 may extend beyond lip 118. This can allow panel 102 to have a greater size than the top of a ladder.

In some exemplary embodiments, lip 118 may further be provided as a contiguous perimeter of a rectangle. In other exemplary embodiments, as shown in FIG. 5b, lip 118 may be provided as plurality of separate lip members 119, defining a recess 120 therebetween. In yet other exemplary embodiments, the positions of lip members 119 may be adjustable, so as to allow ladder caddy 100 to be adaptable to a variety of ladder top dimensions. Adjustability for lip members 119 may be provided in any known manner. For example, lip members 119 may include a plurality of tabs that may be received within a plurality of recesses defined in the lower surface of panel 102, thereby allowing lip members 119 to be moved from one set of recesses to another set of recesses. As another example, lip members 119 may be slidably adjustable.

In yet other exemplary embodiments, as shown in FIG. 5c, lip 118 may extend from the periphery of panel 102 to the periphery of recess 120. In such embodiments, some or all of apertures 104 and/or recesses 106 may extend through the height of lip 118.

Additionally, a plurality of hooks 120 may be provided on the edge of panel 102 or on lip 118. Hooks 120 may be provided in any desired number, and maybe provided on one or more of the front, rear, and side edges of panel 120 or lip 118. Hooks 120 may be made from any desired material, and may have any desired shape and size that allows caddy 100 to function as described herein.

Caddy 100 may also include a plurality of pockets 122. Pockets 122 may be made of any desired material, such as fabric, and may be constructed in any desired manner. In some exemplary embodiments. pockets 122 may be fabricated as single pocket, which may be then divided, for example by seams or the like. In other exemplary embodiments, pockets 122 may be provided separately. Pockets 122 may further include structures for suspending pockets 122 from hooks 120, such as apertures, eyelets, loops, or the like. Pockets 122 may therefore be detachably coupled to caddy 100.

Caddy 100 may further include coupling members 124 coupled thereto. Coupling members 124 may provide additional coupling points between caddy 100 and a ladder. Coupling members 124 may couple to the rails of a ladder in any desired manner. For example, coupling members 124 may be provided as brackets that can frictionally engage the rails of the ladder. Alternatively, coupling members 124 may be coupled to the ladder by fasteners, adhesives, rope, and so forth. Coupling members 124 may be pivotably coupled to caddy 100, for example along the side edges of panel 102 or lip 108.

It should be appreciated that caddy 100, as well as the components thereof, may have any desired size, shape or dimensions that allow the caddy to function as described herein.

Turning to FIG. 7, according to another exemplary embodiment, a ladder 250 having a caddy 200 may be disclosed. Ladder 250 may have any ladder configuration known in the art, such as a folding ladder or a fixed ladder. For example, ladder 250 may include at least a first pair of rails 252. In some exemplary embodiments, ladder 250 may also include a second pair of rails 254. Rungs 256 may extend between the rails 252 of the first pair of rails and/or between the rails 254 of the second pair of rails. A rail 252 may be coupled to a rail 254 by a folding spreader bar 258, which may be lockable. Ladder 250 may further include at least a pair of wheels 260, which may be lockable, coupled to the lower ends of rails 252 and/or 254. Any additional elements for ladder 250 may be contemplated and provided as desired without departing from the scope of the embodiments disclosed herein.

Caddy 200 may be provided in lieu of the top of ladder 250. Caddy 200 may include substantially similar features to caddy 100, which are labeled by similar numbers, but having a leading digit of 2. That is, caddy 200 may include a panel 202, apertures 204, recesses 206, magnetic elements 208, central aperture 210 with a reinforcing member 214, hooks 220 and pockets 222. Each such element may be implemented substantially similarly to the embodiment of caddy 100, described above.

Caddy 200 may be pivotably coupled to each of rails 252, 254 by any desired pivotable coupling, so as to allow ladder 250 to be folded or collapsed. In some exemplary embodiments, panel 202 of caddy 200 may be divided by a hinge 230, thereby allowing caddy 200 to be split into two portions hingedly coupled to each other, for example to facilitate collapsing ladder 250. Hinge 230 may be implemented, for example, such that when ladder 250 is collapsed, the lower faces of the two portions of panel 202 are oriented to face each other.

It should be appreciated that ladder 200, as well as the components thereof, may have any desired size, shape or dimensions that allow the ladder to function as described herein.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A ladder caddy, comprising:
a planar panel having an upper surface, a lower surface and a height;
at least one first aperture defined in the planar panel and extending through the height of the planar panel; and
at least one lip extending from the lower surface of the planar panel, the at least one lip circumscribing a first recess.

2. The ladder caddy of claim 1, further comprising a plurality of second apertures defined in the planar panel and extending through the height of the planar panel.

3. The ladder caddy of claim 1, wherein the first aperture is oriented concentrically with respect to the planar panel.

4. The ladder caddy of claim 1, further comprising a plurality of second recesses defined in the upper surface of the planar panel.

5. The ladder caddy of claim 4, wherein at least one second recess includes a magnetic element.

6. The ladder caddy of claim 1, further comprising a magnetic element disposed on a portion of the upper surface of the planar panel.

7. The ladder caddy of claim 1, further comprising at least one hook coupled to the planar panel.

8. The ladder caddy of claim 1, further comprising at least one pocket coupled to the planar panel.

9. The ladder caddy of claim 1, further comprising at least two coupling members coupled to one of the planar panel or the at least one lip.

10. A ladder comprising the ladder caddy of claim 1.

11. A ladder, comprising:
a top panel, the top panel being planar and having an upper surface, a lower surface and a height;
at least one first aperture defined in the top panel and extending through the height of the top panel; and
at least one pair of rails coupled to the top panel.

12. The ladder of claim 11, further comprising a plurality of second apertures defined in the top panel and extending through the height of the top panel.

13. The ladder of claim 11, wherein the first aperture is oriented concentrically with respect to the top panel.

14. The ladder of claim 11, further comprising a plurality of second recesses defined in the upper surface of the top panel.

15. The ladder of claim 14, wherein at least one second recess includes a magnetic element.

16. The ladder of claim 11, further comprising a magnetic element disposed on a portion of the upper surface of the top panel.

17. The ladder of claim 11, further comprising at least one hook coupled to the top panel.

18. The ladder of claim 11, further comprising at least one pocket coupled to the top panel.
